(19) United States
(12) Patent Application Publication
(10) Pub. No.: US 2010/0332334 A1
(43) Pub. Date: Dec. 30, 2010

(54) SYSTEM AND METHOD FOR SENDING MONEY TO A RECIPIENT

(76) Inventor: Craig Patrick Kilfoil, County Cork (IE)

Correspondence Address: CHARTER IP, LLC, P.O. BOX 64, The Plains, VA, 20198, US

(21) Appl. No.: 12/747,190

(22) PCT Filed: Dec. 11, 2007
(86) PCT No.: PCT/IB07/55018

§ 371 Date: Sep. 14, 2010

(51) Int. Cl. G06Q 40/00; G06Q 20/00

(52) U.S. Cl. 705/16; 235/379; 235/380; 705/43

(57) ABSTRACT

The invention provides a system and method for sending money, locally or internationally, which method includes the steps of, issuing a sender of money with a virtual (credit or debit) card number and a card expiry date, communicating to the intended recipient of the money the virtual card number and card expiry date, presenting the virtual card number and, optionally, the card expiry date, to any merchant with a point-of-sale terminal that is capable of processing credit and/or debit card transactions, processing a key-entered purchase or cash-back transaction, on the point-of sale terminal by keying in the virtual card number provided by the recipient into the point-of-sale, optionally together with the card expiry date and the amount, processing, also known as authorizing, settling and clearing, with a virtual card system, the key-entered transaction by credit and/or debit card transaction clearing means so that the funds are cleared as available to the merchant, and the merchant paying the cleared amount to the recipient, optionally less a processing fee charged to the recipient. The credit and/or debit card accepting terminal also accepts Visa, MasterCard, American express, Diners Club, Discover, JCB, Relation Card and/or CUP credit or debit cards.

### FIELD OF THE INVENTION

The invention relates to a system and method for sending money to a recipient.

### BACKGROUND OF THE INVENTION

The inventor is aware of current money transfer systems, for example, Western Union Money Transfer™. These systems are complex and require verification by the paying out member of the identity of the recipient to ensure that the correct person is paid out and relies on the system operator having a physical point of presence and proprietary hardware and software at each point of presence to process the payments. The Invention addresses this expensive and complex requirement by all other money transfer systems to have a physical point of presence and proprietary equipment to pay out money to recipients.

The inventor is also aware of the international networks for processing and clearing credit and debit card transactions and the efficiency thereof.

### SUMMARY OF THE INVENTION

The invention relates to a system for implementing value transfer from a sender to a recipient, the system including:
a money transfer system issuing virtual credit and/or debit cards;
a point-of-sale terminal operated by a merchant, which includes a processor, a memory, and a communication interface, communicably coupling the point-of-sale terminal to a communication network via the communication interface, wherein a transaction system, sometimes known as an interchange system, compatible with the type of virtual card issued by the money transfer system is accessible by the point-of-sale device via the communication network, the transaction system configured to process transactions between a merchant and customers, wherein

a virtual credit and/or debit card is purchased by the sender, which virtual credit and/or debit card is single use or re-usable i.e. re-loadable, said card being purchased from a in person, using a device, over the Internet or a telephone, the sender communicating one or more of the virtual card number, expiry date, the amount being sent, and optionally the virtual card CVV and/or CVC (card verification value and/or card verification code) to the recipient of value, said recipient approaching any merchant having a credit and/or debit card accepting point-of-sale terminal which accepts various types of credit and/or debit cards for payment from customers, and processing a transaction up to the amount of the virtual card, the merchant paying the recipient the amount of the transaction in cash or crediting an account, optionally less any transaction associated costs.

Said card may be purchased by the sender in the form of a voucher represented as a physical voucher or represented as a virtual voucher by printing or displaying the card data required, from a merchant, an ATM, a self service terminal Kiosk, over the counter, over the internet, a telephone, a mobile phone, a portable device capable of on-line or off-line electronic voucher distribution or from a point-of-sale device.

According to a second aspect of the invention, there is provided a method for sending money, locally or internationally, which method includes the steps of:
issuing a sender of money with a virtual (credit or debit) card number and a card expiry date;
communicating to the intended recipient of the money the virtual card number and card expiry date;
presenting the virtual card number and, optionally, the card expiry date, to any merchant with a point-of-sale terminal that is capable of processing credit and/or debit card transactions;
processing a key-entered purchase or cash-back transaction, on the point-of sale terminal by keying in the virtual card number and amount required, provided by the recipient into the point-of-sale, optionally together with the card expiry date and CVV;
processing, also known as authorizing, settling and clearing, with a virtual card system, the key-entered transaction by credit and/or debit card transaction clearing means so that the funds are cleared as available to the merchant; and
the merchant paying the approved amount to the recipient, optionally less a processing fee charged to the recipient.

A method in which the credit and/or debit card accepting terminal accepts Visa, MasterCard, American express, Diners Club, Discover, JCB, Relation Card and/ or CUP credit or debit cards.

The description which follows below forms an integral part of the disclosure of the invention as if specifically reproduced above under the heading “Summary of the Invention”.

### SPECIFIC DESCRIPTION OF EXAMPLES OF THE INVENTION

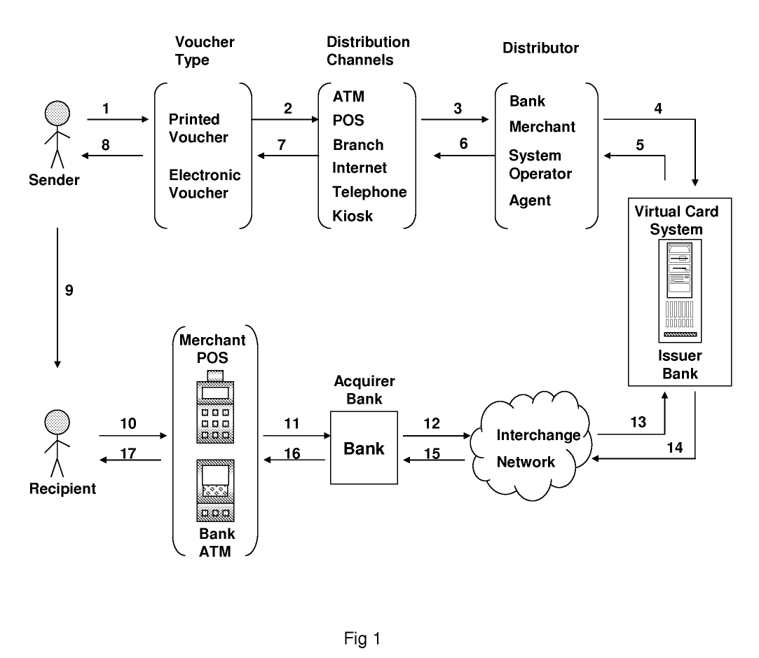

The invention will now be described, by way of non-limiting example only, with reference to the description and a flow diagram shown in FIG. 1:

### Process Description

1 The Sender purchases a Virtual Card of a pre-dominated value or a value as selected by the Sender, represented as a physical pre-printed voucher or an electronic voucher that is printed or displayed on or by the distribution channel device; paying the value of the money transfer voucher and optionally a service fee.

2 The virtual card is sourced from a distribution channel physically or by the distribution channel device.

3 If not already active in the Money Transfer system, the Virtual card is requested to be activated by the Distributor via a device.

4 The Virtual Card system activates a pre-printed Virtual Card or provides a Virtual Card, activates it and makes it available for redemption.

5 The Virtual Card system replies to the Distributor device that the Virtual card is active or delivers a Virtual card number, expiry date and optionally the CVV (CVC).

6 The Device, if required, confirms a Virtual Card has been activated if not already.

7 The Device, if required prints or displays the Virtual card details.

8 The Sender receives the Virtual Card details and pays for it.

9 The Sender gives the Recipient the Virtual Card details and the monetary value that the Virtual card represents and optionally the type of association card issued, such as MasterCard or Visa, American Express, Discover, Relation Card or JCB.

10 The Recipient approaches any Merchant that has a POS device or Bank ATM that accepts the card association brand. Optionally, the Merchant and/or the ATM may display a trade mark of the Money Transfer scheme.

11 The Merchant processes a ‘key entered’ transaction on a standard and un-altered POS device supplied by an acquiring bank; or an ATM processes a key entered transaction for monetary amount required. Optionally the Merchant or ATM provider levies a fee for the disbursement process.

12 The acquirer bank of the Merchant or ATM processes a key entered purchase transaction or cash-back transaction into the appropriate card association interchange network.

13 The Interchange network forwards the authorization request to the virtual card issuing bank virtual card system for approval.

14 The Virtual card system validates the virtual card details and monetary amount requested and approves the transaction.

15 The interchange network responds to the Acquirer bank and prepares to settle the monetary value, including fees and/or commissions due between the parties.

16 Acquirer bank responds to the Merchant POS and prepares to settle monetary value of the transaction to the merchant bank account, including fees or commissions due; Or the ATM is instructed to disburse the cash requested, less any fees due.

17 Merchant disburses the cash requested optionally less any fee; The ATM dispenses cash optionally less a fee.

Note: Payment of value, legal tender or not, by the Sender to purchase a Virtual Card is not prescribed and typical payment tender as processed traditionally is likely suitable.

The invention can be used to transfer money through the use of millions of existing point-of-sale terminals already deployed without modification, with merchants all over the world and hundreds of thousands of ATM's deployed worldwide with minor modification.

More particularly, there is provided in the embodiments of the invention utilising existing transaction types available on existing point-of-sale terminals and ATM's that accept the globally recognized card association cards such as Visa, MasterCard, American Express, Diners Club, Discover, JCB, Relation Card or CUP (China Union Pay) and their transaction clearing systems.

Thus any merchant who has a standard point-of-sale terminal or who could apply for one, now becomes a money transfer agent without needing to purchase any unique equipment or without requiring modification of the point-of-sale hardware or software in any way.

Optionally an ATM provider without needing to purchase any equipment or without requiring modification of the ATM hardware but possibly minor software changes, may become a money transfer agent.

The claims which follow form an integral part of the disclosure of the invention as if specifically reproduced hereabove.

1. A system for implementing value transfer from a sender to a recipient, comprising:
a money transfer system issuing a card including one of virtual credit and debit cards;
a point-of-sale terminal operated by a merchant or an ATM terminal operated by or on behalf of a bank; which includes a processor, a memory, and a communication interface, communicably coupling the terminal to a communication network via the communication interface, wherein a transaction system, sometimes known as an interchange system, compatible with the type of card issued by the money transfer system is accessible by the point-of-sale device via the communication network, the transaction system configured to process transactions between a merchant and customers or between ATM's and customers, wherein
the card is purchased by the sender and is single use or re-usable, said card being purchased from a device, in person, over the Internet, a mobile phone, a telephone, a Kiosk, a POS, or ATM; the sender communicating one or more of the card number, expiry date, the amount being sent, and optionally the card CVV and/or CVC to the recipient of value, said recipient approaching any merchant having at least one of a credit debit card accepting point-of-sale terminal which accepts at least one of credit debit cards for payment from customers, and processing a transaction up to the amount of the card, the merchant paying the recipient the amount of the transaction in cash or crediting an account, optionally less any transaction associated costs.

2. system claim 1, wherein said card is purchased by the sender in the form of a voucher represented as a physical voucher or represented as a virtual voucher by printing or displaying the card data required, from a merchant, an ATM, a self service terminal Kiosk, over the counter, over the internet, a telephone, a cellular phone, a portable device capable of on-line or off-line electronic voucher distribution, or a point-of-sale device.

3. A method for sending money, locally or internationally, comprising:
issuing a sender of money with a virtual (credit or debit) card number and a card expiry date;
communicating to the intended recipient of the money the virtual card number and card expiry date;
presenting the virtual card number and amount requested, optionally, the card expiry date and card verification value (CVV or CVC), to any merchant with a point-of-sale terminal that is capable of processing at least one of credit debit card transactions;
processing a key-entered purchase or cash-back transaction, on the point-of sale terminal by keying in the virtual card number and amount requested provided by the recipient into the point-of-sale, optionally together with the card expiry date and the amount;
processing for authorization, settling and clearing, with a virtual card system, the key-entered transaction by card transaction clearing means so that the funds are cleared as available to the merchant; and
the merchant paying the cleared amount to the recipient, optionally less a processing fee charged to the recipient.

4. A method for sending money, locally or internationally, comprising:
issuing a sender of money with a virtual (credit or debit) card number and a card expiry date;
communicating to the intended recipient of the money the virtual card number and card expiry date;
entering the virtual card number and, optionally, the card expiry date, into an ATM that is capable of processing at least one of credit debit card transactions;
processing a key-entered purchase or cash-back transaction, from the ATM terminal by keying in the virtual card number provided by the recipient into the ATM, optionally together with the card expiry date and the amount;
processing for authorization, settling and clearing, with a virtual card system, the key-entered transaction by card transaction clearing means so that the funds are cleared as available to the ATM acquirer; and
the ATM disbursing the cleared amount to the recipient or optionally crediting an account; optionally less a processing fee charged to the recipient.

5. method claim 3, in which the point-of-sale terminal accepts standard credit or debit cards.

6. method claim 3, in which the merchant credits the bank account of the recipient;

7. method claim 4, in which a provider of the ATM or Bank credits bank account of the recipient
